(19) United States
(12) Patent Application Publication
(10) Pub. No.: US 2003/0203781 A1
(43) Pub. Date: Oct. 30, 2003

(54) Low modulus belt

(76) Inventors: Susan Welk, Lakewood, CO (US); Paul S. Knutson, Aurora, CO (US)

Correspondence Address: Jeffrey Thurnau, The Gates Corporation, Mail Stop 31-4-1-A3, 900 S. Broadway, Denver, CO, 80209, US

(21) Appl. No.: 10/133,993

(22) Filed: Apr. 25, 2002

(51) Int. Cl. F16G 1/00; F16G 9/00

(52) U.S. Cl. 474/237; 474/260; 474/263

(57) ABSTRACT

A belt having an elastomeric body and tensile cord embedded therein. The tensile cord comprises a polyamide 4.6 core with an outer sheath of polyester staple fibers. The modulus of the belt is in the range of approximately 1200 N/mm to 4500 N/mm.

### FIELD OF THE INVENTION

The invention relates to a power transmission belt and more particularly to a low modulus power transmission belt.

### BACKGROUND OF THE INVENTION

Power transmission belts are widely used to transmit rotary power. A belt is generally installed between a driver and driven pulley, such as in the case of an accessory belt drive on a vehicle engine.

The belt comprises a tensile cord embedded in an elastomeric material. The tensile cord, or cords, are oriented parallel to a longitudinal axis in order to maximize a load carrying capability. The tensile cord is wound on a belt build in a continuous manner during fabrication.

Power transmission belts must possess sufficient tensile strength to allow a required torque, and load, to be transmitted between pulleys.

A belt having a high tensile strength also will generally have a commensurately high modulus. A belt having a high modulus will be relatively stiff. Further, installation of a prior art high modulus belt requires moveable axis pulleys.

A low modulus belt may be used in situations where the torque to be transmitted is less than that required for a high load application. Low modulus belts are fabricated using tensile cords with a predetermined preload, or little or no preload. They may be fabricated using tensile cords having a twist as well. The material selected for the tensile cord will have the greatest effect on the modulus of the belt. Polyamide 4.6 is known for such use.

Representative of the art is EP 0 625 650 to Gates that discloses a low modulus belt having a tensile cord wound with a preload in a longitudinal direction.

Also representative of the art is U.S. Pat. No. 6,033,331 to Winninger et al. (2000) which discloses a belt having a supporting structure such that the belt exhibits an average stress-elongation slope ranging from 12 to 20 daN/% of elongation per width centimeter.

The prior art teaches use of a tensile cord comprising polyamide 4.6 twisted strands. Use of a single material for the tensile cord limits the modulus range for a belt.

What is needed is a low modulus belt having a hybrid tensile cord comprising at least two different materials. What is needed is a low modulus belt having a tensile cord comprising a polyamide 4.6 core having an outer sheath of polyester staple fibers. What is needed is a low modulus belt having a modulus in the range of approximately 1200 N/mm to 4500 N/mm. The present invention meets these needs.

### SUMMARY OF THE INVENTION

The primary aspect of the invention is to provide a low modulus belt having a hybrid tensile cord comprising at least two different materials.

Another aspect of the invention is to provide a low modulus belt having a tensile cord comprising a polyamide 4.6 core having an outer sheath of polyester staple fibers on an outer surface.

Another aspect of the invention is to provide a low modulus belt having a modulus in the range of approximately 1200 N/mm to 4500 N/mm.

Other aspects of the invention will be pointed out or made obvious by the following description of the invention and the accompanying drawings.

The invention comprises a low modulus belt having an elastomeric body and tensile cord embedded therein. The tensile cord comprises a polyamide 4.6 core having an outer layer of polyester staple fibers. The modulus of the belt is in the range of approximately 1200 N/mm to 4000 N/mm.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a side view of a tensile member having a single strand core.

FIG. 1a is a cross-sectional view at line 1a-1a in FIG. 1.

FIG. 2 is a cross-sectional view of an inventive belt.

FIG. 3 is a side view of a tensile member having a twisted strand core.

FIG. 3a is a cross-sectional view at line 3a-3a in FIG. 3.

### DETAILED DESCRIPTION OF THE PREFERRED EMBODIMENT

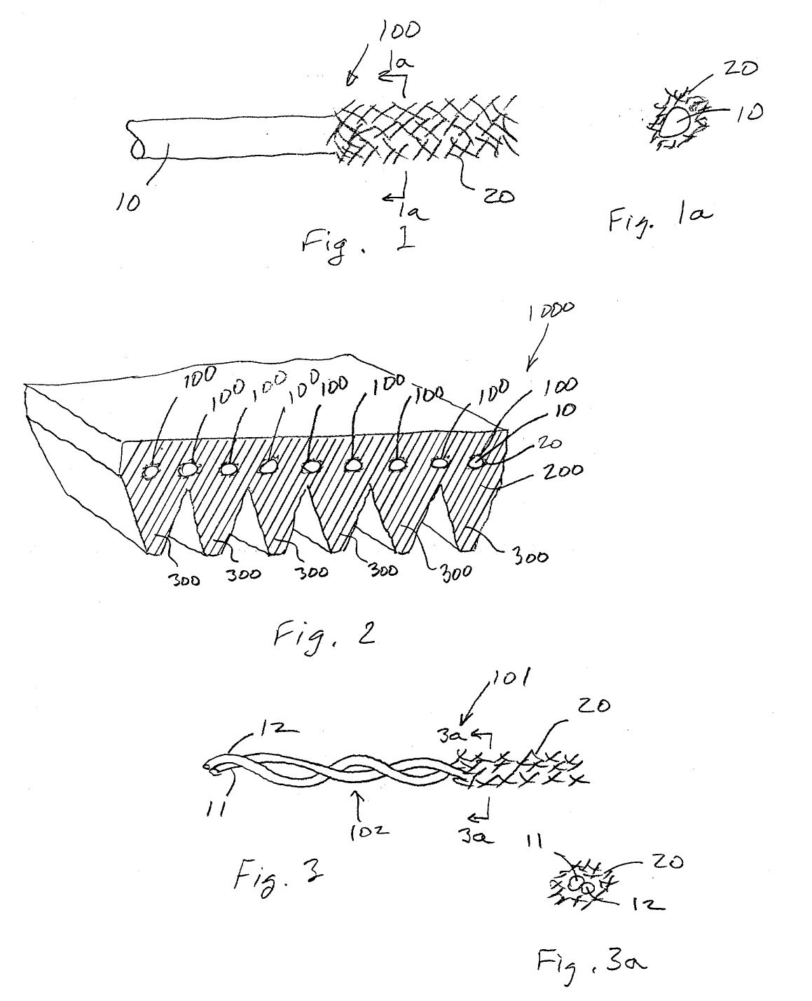

FIG. 1 is a side view of a tensile member having a single strand core. Tensile member 100 is a hybrid composition which comprises a core 10 covered by staple fibers 20.

Core 10 comprises polyamide 4.6 in the preferred embodiment. Core 10 may also comprise polyamide 6, polyamide 6,6 and polyamide 12, and all equivalents. Core 10 may comprise either a single strand or may comprise a twisted yarn comprising two or more strands.

Core 10 is covered or wrapped in a sheath of staple fibers 20. Staple fibers 20 substantially comprise polyester. The polyester fibers have a length in the range of approximately 10-40 mm. The polyester fibers have a thickness in the range of approximately 10-30 μm.

Prior art belts having tensile members comprising a strand of polyamide 4.6 have very low modulii, for example, in the range of 40 N/mm to 800 N/mm. While this is suitable for use in appliances such as washing machines, it is too low for automotive applications. In the inventive belt, the polyester sheath has the desirable effect of increasing the modulus of the belt over a comparable belt without a polyester sheath, while retaining the desirable modulus and elasticity of polyamide 4.6.

Staple fibers 20 are applied to core 10 using a friction spinning process known in the art. For example, the friction spinning process as described by the University of Aachen, Department of Textile Technology. A suitable cord is also manufactured by Fehrer AG (Lin is the z-Austria) using the DREF™ process.

FIG. 1a is a cross-sectional view at line 1a-1a in FIG. 1. Fibers 20 are shown spun into a covering or sheath around the outside of core strand 10.

FIG. 2 is a cross-sectional view of an inventive belt. Belt 1000 comprises tensile members 100, which are shown embedded in elastomeric body 200. Tensile members 100 extend in a longitudinal direction along an endless length of the belt. Ribs 300 project from one side of the belt and extend longitudinally along an endless length of the belt as well.

Elastomeric body 200 may comprise natural or synthetic rubbers, polychloroprene, alkylated chlorosulphonated material, hydrogenated nitrile butadiene rubber (HNBR), or EPDM, as well as equivalents of any of the foregoing.

The inventive belt has an elastic modulus relative to the belt width and measured in the lengthwise direction in the range of 1200 N/mm to 4500 N/mm per belt strand. Said measurement comprises a stress-strain curve average slope from a stress range of 150 to 300 N/rib/strand on the third of three belt elongation cycles. This results in an elongation in the range of approximately 0.5% to 10%.

The belt test apparatus includes a tensile test machine, such as an Instron® or equivalent known in the art. To test, a belt is placed in an inverted position on a set of test pulleys in the tensile test machine. Inverted meaning the ribbed portion is not engaged with the test pulleys. The test pulleys are not rotated during the test. The belt is subjected to three load cycles on the test machine in order to stabilize the belt. The belt modulus is determined from the third of three load cycles on the test machine.

FIG. 3 is a side view of a tensile member having a twisted strand core. Tensile member 101 comprises strands 11 and 12 which are twisted to form a core. Strands 11 and 12 may have either an “S” or “Z” twist. Fibers 20 are spun over strands 11, 12 using the method as described for FIG. 1. Core 102 may comprise two or more strands twisted together.

FIG. 3a is a cross-sectional view at line 3a-3a in FIG. 3. Fibers 20 are shown spun around the outside of twisted core strands 11, 12.

Although a single form of the invention has been described herein, it will be obvious to those skilled in the art that variations may be made in the construction and relation of parts without departing from the spirit and scope of the invention described herein.

I claim:

1. A belt comprising:
an elastomeric body;
a tensile member embedded in the elastomeric body;
the tensile member comprises a strand substantially of polyamide 4.6 and having an outer layer of fibers; and
the belt having a stress-elongation diagram which exhibits an average slope ranging from approximately 1200 N/mm to 4500 N/mm.

2. The belt as in claim 1, wherein the fibers have length in the range of approximately 10-40 mm.

3. The belt as in claim 2 wherein the fibers have a thickness in the range of approximately 10 to 30 μm.

4. The belt as in claim 1 wherein the fibers substantially comprise polyester.

5. A belt comprising:
an elastomeric body;
a tensile member embedded in the elastomeric body, the tensile member comprises at least two strands of polyamide 4.6 twisted together and having fibers formed about an outer surface of the twisted strands; and
the belt having a stress-elongation diagram which exhibits an average slope in the range of approximately 1200 N/mm to 4500 N/mm.

6. The belt as in claim 5, wherein the fibers have length in the range of approximately 10-40 mm.

7. The belt as in claim 5 wherein the fibers have a thickness in the range of approximately 10 to 30 μm.

8. The belt as in claim 5 wherein the fibers substantially comprise polyester.
